(19) United States
(12) Patent Application Publication
(10) Pub. No.: US 2012/0109577 A1
(43) Pub. Date: May 3, 2012

(54) DISTANCE MEASURING DEVICE FOR GOLF

(75) Inventors: Scott Nyhart, Shawnee, KS (US); Brian Marquess, Olathe, KS (US); Jordan Vermillion, Overland Park, KS (US)

(73) Assignee: BUSHNELL INC., Overland Park, KS (US)

(21) Appl. No.: 12/917,142

(22) Filed: Nov. 1, 2010

(51) Int. Cl. G06F 15/00

(52) U.S. Cl. 702/159

(57) ABSTRACT

An integrated distance measuring device for golf comprises a satellite navigation receiver operable to determine a current location of the device; a laser rangefinder operable to determine a distance from the current location of the device to an object on a golf course; a compass operable to determine a bearing of the device when it is aimed at the object; a display; and a computing device. The computing device is programmed to determine a location of the object as a function of the current location of the device, the distance to the object, and the bearing of the device. The computing device may also be programmed to calculate a distance between the object and a second object on the golf course as a function of the location of the object and pre-mapped location information for the second object. The computing device may also be programmed to present on the display a representation of the current location of the device, a representation of the location of the object, a representation of the second object, a representation of the distance between the current location of the device and the location of the object, as well as a representation of the distance between the object and the second object.

### BACKGROUND

Golfers often desire to know the distance to greens, flag sticks, bunkers, or other spots or areas on golf courses. The two most popular distance measuring devices for golf are laser rangefinders and GPS devices.

Laser rangefinders transmit laser pulses at a target and receive reflected pulses therefrom. An internal clock monitors the time difference between the transmitted and received pulses, halves the time difference and multiplies it by the speed of light to thereby derive a distance from the rangefinder to the target. Laser rangefinders are highly accurate, but they require a line of sight to a target and are therefore not as useful when objects such as trees, hills, etc. block a player's view of a target.

GPS devices acquire satellite signals from orbiting GPS satellites, calculate their current position based on these signals, and then calculate distances between the device and pre-mapped targets. GPS devices do not have to be aimed and therefore do not require a line of sight to a target, but they are less accurate than laser rangefinders and are therefore not as useful when a golfer wants to know a precise distance to a target. Moreover, GPS devices only show the distance to selected, pre-mapped targets such as quadrants of greens, bunkers, etc. and are therefore not as useful when a golfer wants to know a distance to a non-mapped target.

Because laser rangefinders and GPS devices both have advantages and disadvantages, many golfers carry one of each. However, carrying two devices while golfing is cumbersome and often slows a player's pace of play as he or she decides which device is the most appropriate for a particular situation. Moreover, even when carrying both of these devices, a user is unable to determine certain distance and location information that may be helpful while golfing.

### SUMMARY

The present invention solves the above-described problems and provides a distinct advance in the art of distance measuring devices for golf use by providing an integrated distance measuring device for golf that combines the features of both a laser rangefinder and a GPS device and that provides additional features and information not available with either of these devices.

An embodiment of the device broadly comprises a satellite navigation receiver operable to determine a golfer's current location; a laser rangefinder operable to determine a distance from the current location to an object on a golf course; a compass operable to determine a bearing of the device when it is aimed at the object; a display; and a computing device that receives location, distance, and bearing information from the satellite navigation receiver, laser rangefinder, and compass and calculates location information therefrom.

In one embodiment the computing device is programmed to determine a location of a remotely sighted object as a function of the current location of the device, the distance to the object, and the bearing of the device. For example, while standing on a tee box, the satellite navigation receiver determines the golfer's current location. The golfer may then aim the device at a target in a fairway and determine the distance to the target with the laser rangefinder. When the laser rangefinder is operated, the compass determines the bearing of the device. The computing device receives the current location of the device from the satellite navigation receiver, the distance to the target from the laser rangefinder, and the bearing from the compass and uses this information to calculate the geographic coordinates of the target. These geographic coordinates may be displayed on a display or used for certain calculations as described in more detail below.

The computing device may also be programmed to calculate a distance between a remotely sighted object such as a portion of a fairway and a second object such as a green. The location of the first object is calculated as described above. The location of the second object is determined with pre-mapped location information. The computing device determines the distance to the first object and the distance between the first and second objects based on these locations. This allows a golfer to select a desired lay-up region in a fairway and to determine both the distance from a tee box to the lay-up region and the distance from the lay-up region to a green.

The computing device may also be programmed to present on the display representations of certain locations and distances. For example, the computing device may present a a representation of the current location of the device, a representation of the location of a first remotely sighted object, a representation of a second object such as a green, a representation of the distance between the current location of the device and the first object, as well as a representation of the distance between the first object and the second object.

The computing device may also permit a user to manually select a spot between the current location of the device and the location of a green or other object by marking the selected spot with a cursor or other pointer on the display. The computing device may then calculate and display a distance between the current location of the device and the selected spot and a distance between the selected spot and the green. This allows a golfer to quickly consider several different lay-up options.

The above-described components of the device are preferably mounted in or on a portable handheld housing. An embodiment of the housing has opposed left and right sidewalls, opposed top and bottom walls, and opposed front and rear walls. All of the walls are sized and configured to permit a user to hold the device with one hand while using both the laser rangefinder and satellite navigation receiver. The display is advantageously positioned in one of the sidewalls of the housing, and the eyepiece of the laser rangefinder is positioned in the front wall of the housing. This permits a user to hold the device with one hand, look through the eyepiece to operate the laser rangefinder, and then simply twist his or her hand to view GPS information on the display.

The sidewall in which the display is mounted further includes a lower, inwardly-projecting ledge. A plurality of user inputs are positioned on the ledge for controlling functions of the satellite navigation receiver and the display. The positioning of these inputs permits a user to easily access and operate them with the thumb of his or her free hand while still holding the device with the opposite hand.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a distance measuring device constructed in accordance with embodiments of the present invention.

FIG. 2 is a side elevational view of the device of FIG. 1.

FIG. 3 is a perspective view showing a golfer using the device to range a target with the laser rangefinder.

FIG. 4 is another perspective view showing the golfer using the device to determine a distance to an object with the satellite navigation receiver.

FIG. 5 is a block diagram depicting the primary components of the device.

FIG. 6 is a block diagram depicting the primary components of the laser rangefinder portion of the device.

FIG. 7 is another block diagram depicting the primary components of the satellite navigation receiver portion of the device.

FIG. 8 is a schematic representation of a global navigation satellite system that may provide signals to the satellite navigation receiver portion of the device.

FIG. 9 is an exemplary screen display depicting a Lay-up mode and other modes of the device.

FIG. 10 is a representation of certain inaccuracies when using the device to remotely mark a point.

FIG. 11 is another representation of the inaccuracies shown in FIG. 10.

FIG. 12 is another exemplary screen display depicting a step in the Remote Marking mode of the device.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

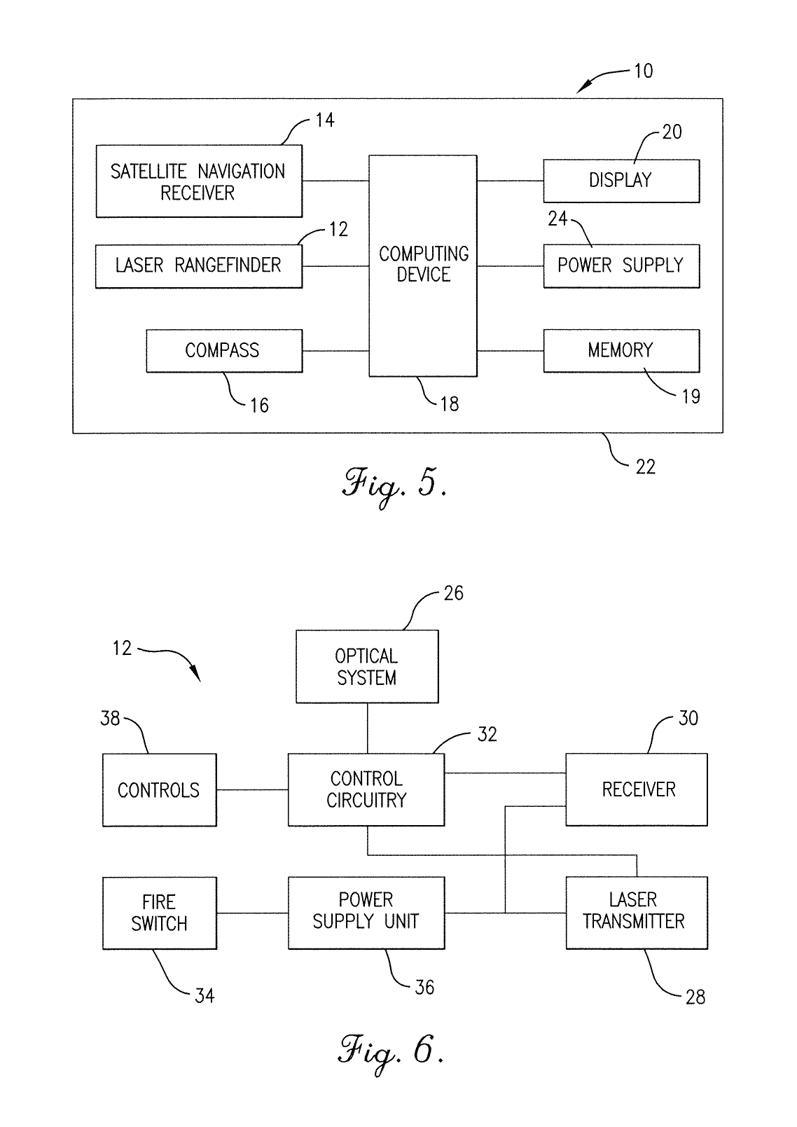

Turning now to the drawing figures, a distance-measuring device 10 constructed in accordance with various embodiments of the invention is illustrated. The device 10 is constructed and configured for determining distances to objects on golf courses such as flag sticks, greens, bunkers, hazards, etc. As best shown in FIG. 5, the device 10 broadly includes a laser rangefinder 12; a satellite navigation receiver 14; a compass 16; a computing device 18; a display 20; and a portable handheld housing 22. The device may also comprise memory 19 and a single power supply 24 for powering the laser rangefinder, satellite navigation receiver, and display.

Turning now to FIG. 6, an embodiment of the laser rangefinder 12 includes an optical system 26 for viewing targets on golf courses; a laser transmitter 28 for transmitting a laser signal toward a target; a receiver 30 for receiving reflections of the signal reflected from the target; and control circuitry 32 for determining a distance to the target. The laser rangefinder may also comprise a fire switch or power button 34 for triggering the laser transmitter 28, a power supply unit 36 coupled with the power supply 24, and one or more user controls 38. Many of the components of the laser rangefinder are conventional and are therefore not described in detail herein.

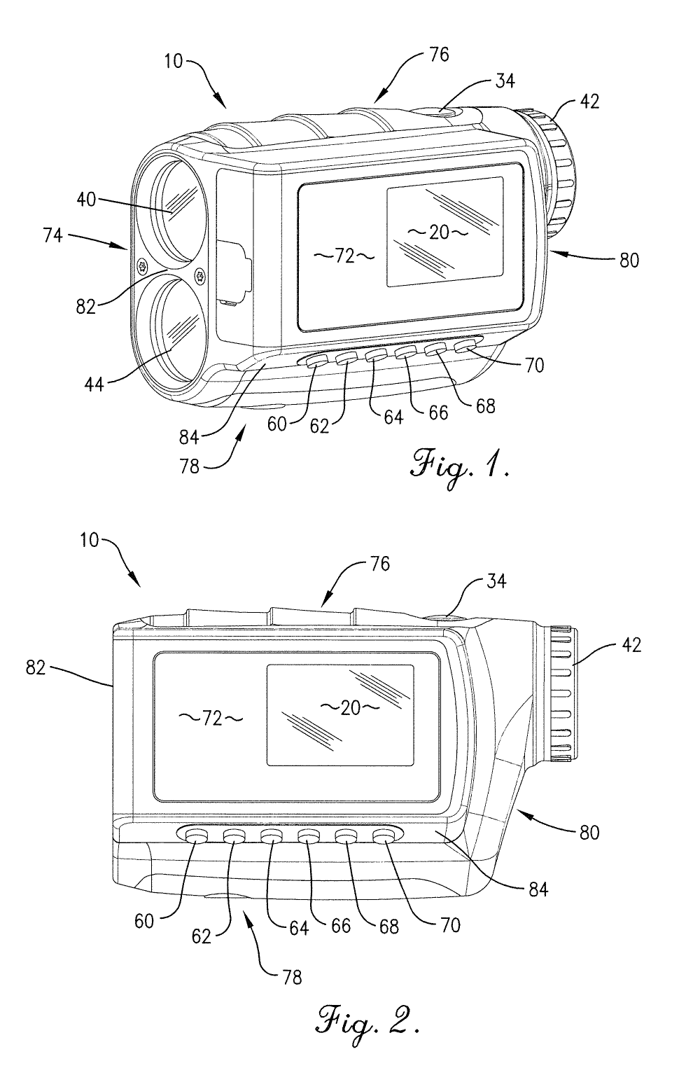

As best shown in FIGS. 1 and 2, an embodiment of the optical system 26 includes an objective lens 40, an eyepiece 42 with diopter adjustment and 5× or 7× magnification, a laser receiver lens 44, and an in-view display. The display may be a liquid crystal display or any other type of display and incorporates illuminated indicators for an aiming circle or reticle, distance measurements, and mode indicators.

The laser transmitter 28 includes an eye-safe FDA Class 1 and LE Class 3A laser emitting diode for directing a laser signal out of the objective lens 40 and toward a target. The laser transmitter 28 also supplies a “fire” signal to the control circuitry 32. Details of an exemplary laser transmitter are disclosed in more detail in U.S. Pat. Nos. 5,612,779, 5,652,651, and 5,926,259, all of which are incorporated into the present application in their entireties by reference.

The receiver 30 includes a laser receiving diode that receives reflections of the laser signal emitted from the laser emitting diode as they are reflected from an object back through a laser receiver lens. Details of an exemplary receiver are disclosed in more detail in the above-referenced U.S. Pat. Nos. 5,612,779, 5,652,651, and 5,926,259.

The control circuitry 32 is operatively coupled with the laser transmitter 28 and the receiver 30 and is configured to determine a distance to a target based on the time of flight of the laser signal. In one embodiment, the control circuitry includes a microprocessor and application-specific integrated circuit (ASIC); a precision timing circuit; an oscillator; and an automatic noise threshold circuit. The control circuitry 32 may also include or be coupled with a mode switch by means of which an operator can change the operating mode and functional operation of the laser rangefinder. The control circuitry 32 may be integrated with or otherwise a part of the computing device 18 or may be a stand-alone circuit.

The control circuitry 32, once enabled via the fire switch 34, is programmed to cause the laser generator to fire a series of laser light pulses, each with a duration of approximately 5 to 100 nanoseconds. Once the laser pulses are reflected off of a target, a portion of each pulse is returned to the receiver 30. Detection of a received pulse triggers the precision timing circuit and automatic noise threshold circuit, each of which is described in detail in the above-referenced U.S. Pat. Nos. 5,612,779, 5,652,651, and 5,926,259. If sufficient pulses are received to perform a reliable range calculation, the calculation locks onto a calculated range and displays the calculated range on the in-view LCD. Additional operational details of the laser rangefinder are discussed below.

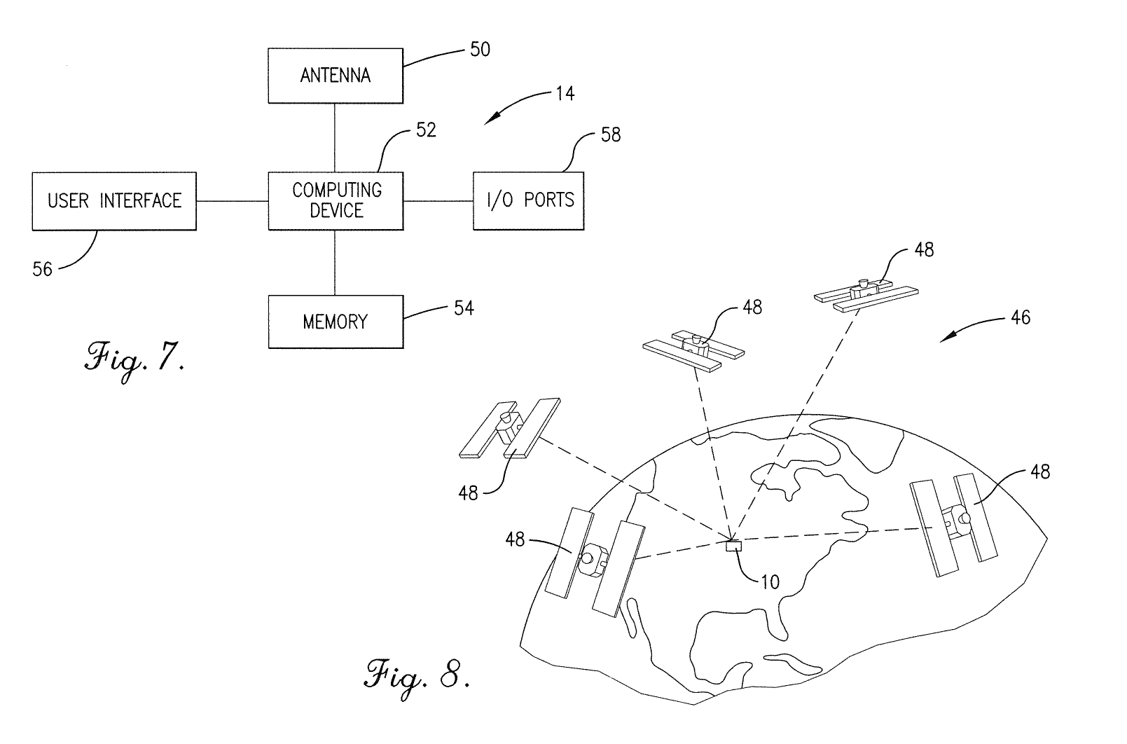

The satellite navigation receiver 14 component of the device 10 will now be described with reference to FIGS. 7 and 8. The satellite navigation receiver 14 may work with any global navigation satellite system (GNSS) such as the global positioning system (GPS) primarily used in the United States, the GLONASS system primarily used in the Soviet Union, or the Galileo system primarily used in Europe. FIG. 8 schematically depicts a GNSS 46 having a plurality of satellites 48 in orbit about the Earth. A satellite navigation receiver device such as the device 10 of the present invention receives satellite signals from the satellites. The satellite signals incorporate time data from an extremely accurate atomic clock and a data stream that identifies the satellite. The device 10 must acquire satellite signals from at least three satellites in order to calculate its two-dimensional position by triangulation.

An embodiment of the satellite navigation receiver 14 is illustrated in FIG. 7 and broadly includes an antenna 50, a computing device 52, memory 54, a user interface 56, and input/output (I/O) ports 58. Many of the components of the satellite navigation receiver 14 are conventional and are therefore not described in detail herein.

The antenna 50 may be a patch antenna, linear antenna, or any other device operable to receive signals from the satellites 48. The antenna may be mounted in or on the housing 22 and is electrically connected to the computing device 52.

The computing device 52 may include one or more processors, controllers, or other devices and is programmed to calculate location and other geographic information as a function of the received satellite signals. In one embodiment, the computing device is part of an application specific integrated circuit (ASIC) similar to that found in commercially-available portable GPS receivers. The computing device 52 may be a part of the computing device 18 and/or the control circuitry 32 or may be a stand-alone device.

The memory 54 may be RAM, ROM, Flash, magnetic, optical, USB memory devices, and/or other conventional memory elements. The memory may be part of the memory 19 or may be stand-alone memory. The memory may store various data associated with operation of the device 10. For example, the memory may store cartographic data showing the tee boxes, fairways, greens, hazards, etc. for selected golf courses or for all known golf courses. The cartographic information is preferably pre-loaded in the memory but may be downloaded to the device via the I/O ports 58.

The memory 54 may also store a map-matching search engine that searches through the database of cartographic information to find known golf courses or golf course holes that match the device's current location. The search engine or other programs executed by the device may also perform calculations related to the cartographic information.

The user interface 56 permits a golfer to operate features of the satellite navigation component 14 and may comprise one or more functionable inputs such as buttons, switches, scroll wheels, a touch screen display, touchpads, trackballs, styluses, or combinations thereof. In the embodiment shown in FIGS. 1 and 2, the user interface 56 includes a number of buttons, including a power button 60 for turning the device on and off, a screen button 62 for displaying distances to additional points of interest, a scroll-up button 64 for scrolling the display up or for selecting another hole on a golf course, a scroll-down button 66 for scrolling the display down or for selecting a previous hole on a golf course, an OK/SHOT button 68 for selecting a highlighted option or activating a shot distance, and an ESC/MENU button 70 for cancelling a current control operation or returning to a previous step, screen, or menu.

The I/O ports 58 permit data and other information to be transferred to and from the device. The I/O ports may include a USB port or mini USB port for coupling with a USB cable connected to another computing device such as a personal computer. Navigational software, cartographic maps and other data and information may be loaded in the device via the I/O ports.

The compass 16 is provided to determine a bearing of the device when it is aimed at a target. The compass may be any conventional magnetic compass, gyro compass, or electronic compass. In one embodiment, the compass provides bearing information to the computing device 18 whenever the fire switch 34 is pressed.

The computing device 18 is in communication with the laser rangefinder 12, the satellite navigation receiver 14, and the compass 16 for receiving data representative of the current location of the device, a horizontal distance to a target, and a bearing of the device. The computing device 18 may be any electronic device or component capable of executing logical and mathematical operations. The computing device may be a single electronic component or it may be a combination of components that provide the requisite functionality. For example, the computing device may comprise microprocessors, microcontrollers, programmable logic controllers (PLCs), field-programmable gate arrays (FPGAs), application specific integrated circuits (ASICs), or any other component or components that are operable to perform, or assist in the performance of, the operations described herein. In some embodiments, the functionality of the computing device 18, the computing device 52, and the control circuitry 32 may be combined in a single ASIC, microprocessor, or other device. The computing device 18 may be coupled with other components of the device 10 through wired or wireless connections.

The memory 19 may be integrated in the computing device 18, may be external memory, or may be part of the memory 54. The memory 19 may be RAM, ROM, Flash, magnetic, optical, USB memory devices, and/or other conventional memory elements. The memory may store various data associated with operation of the device 10. For example, the memory may store cartographic data showing the tee boxes, fairways, greens, hazards, etc. for selected golf courses or for all known golf courses.

One or more computer programs may be stored in or on computer-readable medium such as the memory 19 or the memory 54 for implementing aspects of the present invention. Each computer program preferably comprises an ordered listing of executable instructions for implementing logical functions. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The display 20 presents distance information calculated by the satellite navigation receiver 14 as described below. The display 20 may comprise conventional black and white, monochrome, or color display elements including, but not limited to, Liquid Crystal Display (LCD), Thin Film Transistor (TFT) LCD, Polymer Light Emitting Diode (PLED), Organic Light Emitting Diode (OLED) and/or plasma display devices. The display may incorporate touch-screen electronics to enable a golfer to interact with it by touching or pointing at display areas to provide information to the device.

The power supply 24 provides electrical power to the laser rangefinder 12, satellite navigation receiver 14, compass 16, computing device 18, and display 20. The power supply 24 may comprise conventional power supply elements, such as batteries, battery packs, etc. The power supply may also comprise power conduits, connectors, and receptacles operable to receive batteries, battery connectors, or power cables. For example, the power supply may include both a battery to enable portable operation and a power input for receiving power from an external source. In one embodiment, the power source is an internal rechargeable lithium-ion battery that may be charged via the USB or mini USB port described above. The power supply includes or is coupled with the high voltage (HV) power supply unit 32 that supplies operating power to the laser transmitter 24 of the laser rangefinder.

The housing 22 is handheld or otherwise portable to facilitate easy use while golfing. The housing 22 may be constructed from a suitable lightweight and impact-resistant material such as plastic, nylon, aluminum, or any combination thereof and may include gaskets or seals to make it substantially waterproof or resistant.

An embodiment of the housing 22 illustrated in FIGS. 1 and 2 has opposed left and right sidewalls 72, 74, opposed top and bottom walls 76, 78, and opposed front and rear walls 80, 82. All of the walls are sized and configured to permit a user to hold the device 10 with one hand. The top and bottom walls 76, 78 may be curved and covered with rubber grips to facilitate gripping of the device. The left sidewall 72 includes a lower, inwardly-projecting ledge 84. The user interface 56 of the satellite navigation receiver, such as the buttons 60-70, are positioned on the ledge. In one embodiment, the housing is approximately 4.3″ long measured between the front and rear walls, approximately 2.8″ tall measured between the top and bottom walls, and 1.8″ wide measured between the left and right sidewalls. The entire device only weighs approximately 8.5 ounces.

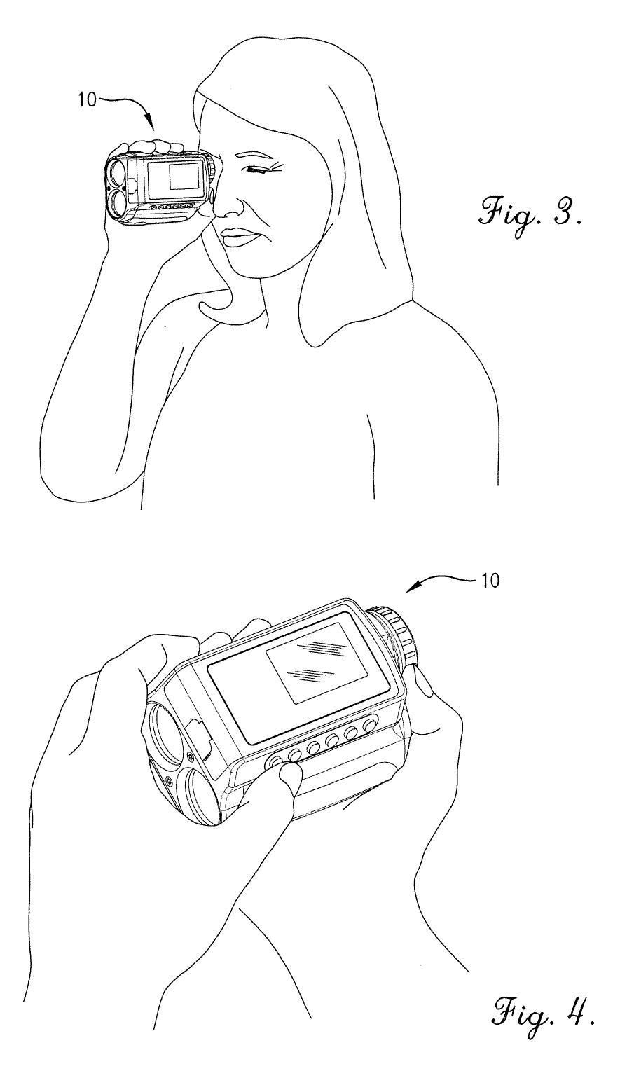

As shown in FIGS. 1-4, the display 20 is advantageously positioned in the left sidewall 72 of the housing, and the eyepiece 42 is positioned in the front wall 80 of the housing. This permits a user to hold the device 10 with his or her right hand and look through the eyepiece 42 to operate the laser rangefinder 12 as shown in FIG. 3. After acquiring a distance reading with the laser rangefinder 12, the user may then simply twist his or her hand to view GPS information on the display 20 without releasing or re-gripping the device as shown in FIG. 4.

Similarly, the positioning of the inputs 60-70 on the ledge 84 permits a golfer to easily access and operate them with the thumb of his or her left hand while still holding the device with the right hand as depicted in FIG. 4. In an alternative embodiment of the invention, the display 20 and user inputs 60-70 may be positioned on the right sidewall so that a left-handed user can hold the device with his or her left hand and operate the user inputs with his or her right thumb.

The above-described device 10 may be used to determine a distance to a target on a golf course with the laser rangefinder 12, the satellite navigation receiver 14, or both. To range a target with the laser rangefinder 12, a golfer looks through the eyepiece 42 as depicted in FIG. 3, aims the device at the target, and views an optically magnified image of the target in the field of view of the rangefinder. The golfer may then press the fire switch 34 once to activate the in-view display. This places an aiming circle or reticle in the center of the field of view.

Once the aiming circle is positioned on the target, the golfer may engage and hold the fire switch 34, causing the laser transmitter 28 to emit a series of laser pulses, as described above. Crosshairs are displayed on the in-view display surrounding the aiming circle to indicate that the laser is transmitting. Once the laser pulses are reflected off of the target, a portion of each pulse is returned to the receiver 30. Detection of a received pulse triggers the precision timing section and automatic noise threshold section of the control circuitry 32. If sufficient pulses are received to perform a reliable range calculation, the control circuitry 32 locks onto a calculated range and displays the calculated range on the in-view display. Once a range has been acquired, the golfer may release the fire switch 34 to de-activate the laser 28. This will cause the reticle or crosshairs to disappear from the in-view display, but the display will remain active and display the last distance measurement for a pre-determined amount of time such as 30 seconds.

The golfer may also use the satellite navigation receiver 14 to determine a distance to a target. For example, after determining the precise distance to a flag stick with the laser rangefinder 12, the golfer may wish to determine the approximate distance to the front, center, or back of the green with the satellite navigation receiver. Or, while playing a course that does not allow carts to leave the cart path, the golfer may wish to use the satellite navigation receiver to determine the approximate distance to a target to select a club or clubs to carry to the golfer's ball. Or, when the golfer does not have a line-of-sight to the flag stick or other target, the or she may use the satellite navigation receiver exclusively.

To use the satellite navigation receiver 14 (after it has been activated by the button 56), the golfer merely twists his or her hand as described above and as illustrated in FIG. 4 to view location and distance information acquired by the satellite navigation receiver on the display. As the golfer is holding the device with his or her right hand and viewing the information on the display, the golfer may operate the user inputs with the thumb of his or her right hand.

The device 10 also performs many functions not provided by either a laser rangefinder or a satellite navigation receiver, even when these devices are used together. For example, in one embodiment, the computing device 18 is programmed to determine a location of an object that has been remotely sighted and ranged with the laser rangefinder 12. The location is calculated as a function of the current location of the device, the distance to the object, and the bearing of the device while aimed at the object. For example, while standing on a tee box, the satellite navigation receiver 14 may determine a golfer's current location. The golfer may then aim the device 10 at a target in a fairway and determine the distance to the target with the laser rangefinder 12. While the laser rangefinder is operated, the compass 16 determines the bearing of the device. The computing device 18 receives the current location of the device from the satellite navigation receiver 14, the distance to the target from the laser rangefinder 12, and the bearing of the device from the compass 16 and uses this information to calculate the geographic coordinates of the target using the equations set forth and described below. These geographic coordinates may be presented on the display or used for certain calculations as described in more detail below.

In another embodiment, the computing device 18 is programmed to calculate a distance between an object that has been remotely sighted and ranged with the laser rangefinder 12 and a second object on the golf course such as a green. The location of the remotely sighted object is determined as described above. The location of the second object is obtained from cartographic map data stored in the memory 19 or 54. The computing device 18 determines the distance between these objects and presents it on the display 20. This allows a golfer to select a desired lay-up spot in a fairway or elsewhere, remotely sight and range the lay-up spot with the laser rangefinder 12, and determine both the distance to the lay-up spot and the distance from the lay-up spot to a green or other target.

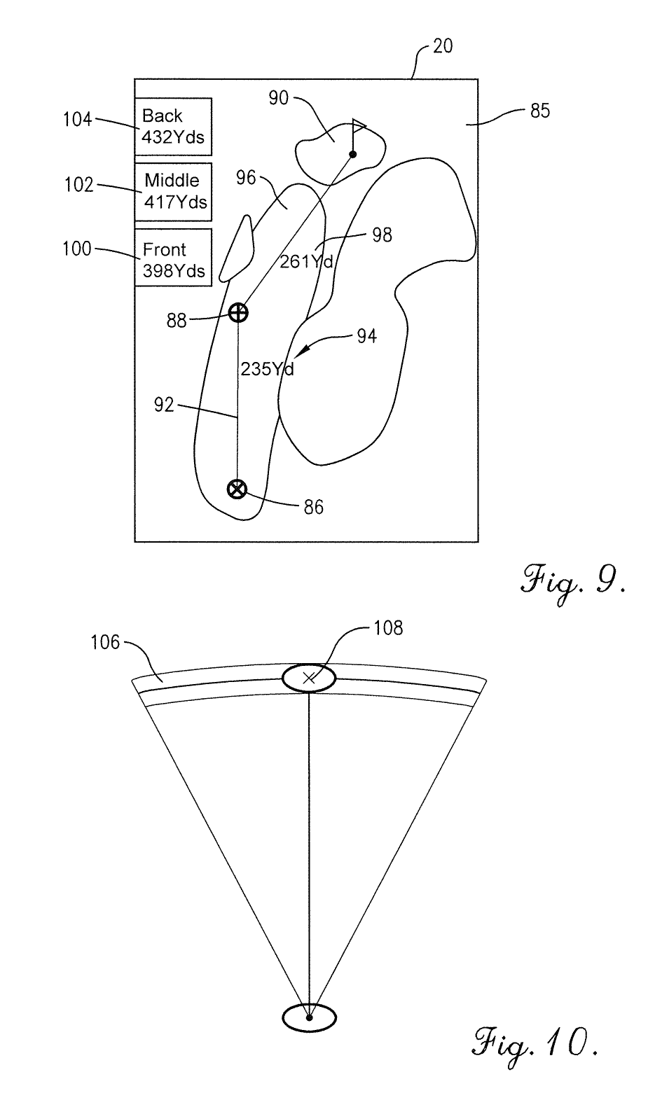

In another embodiment, the computing device 18 is programmed to present on the display 20 representations of certain locations and distances. For example, as shown in FIG. 9, the computing device 18 may display a representation 85 of a golf hole, a marker or icon 86 that represents a golfer's current location as determined by the satellite navigation receiver 14, a marker or icon 88 that represents a spot or object remotely sighted and ranged with the laser rangefinder 12, and a marker or icon 90 that represents a pre-mapped green or flag stick. The computing device may also display a line segment 92 and distance reading 94 between the golfer's current location and the remotely sighted object and a line segment 96 and distance reading 98 between the remotely sighted object and the pre-mapped object. Finally, the computing device 18 may indicate the distance to the front of the green in box 100, the distance to the middle of the green in box 102, and the distance to the back of the green in box 104.

The computing device 18 may also be programmed to calculate the approximate location of a selected object or spot on the display. For example, a golfer may select a spot on the display with a cursor or other pointer, and the computing device 18 then calculates the approximate location of the selected spot, a distance between the current location of the device and the selected spot, and a distance between the selected spot and the green.

The computing device determines the approximate location of the selected spot by considering its position relative to other objects for which locations are pre-mapped and therefore known. Specifically, the computing device maps known location coordinates of objects to the display screen. The cursor or pointer is also mapped to the display screen, so the computing device can translate a selected spot on the display to approximate location coordinates.

The computing device 18 then determines and displays a distance between the golfer's current location, as determined by the satellite navigation receiver, and the selected spot. The computing device 18 may also determine and display a distance between the selected spot and the green.

The computing device 18 determines the geographic coordinates of a remotely sighted and ranged spot with the following equations, where D=the distance ranged with the laser rangefinder 12; A=the angular bearing of the device as measured by the compass 16 when the range measurement is taken; LATmpd is a constant to convert degrees of latitude to meters; and LONmpd is a factor to convert degrees of longitude to meters (LATmpd and LONmpd are defined more fully below).

New latitude=Original latitude+D×Sin (A)/LATmpd

New longitude=Original longitude+D×Cos (A)/LONmpd

Determining the location of a remotely sighted point in this manner is subject to several inaccuracies. Such inaccuracies are based primarily on:

(1) Errors in the current position of the device as determined by the satellite navigation receiver 14. GPS receivers typically have an error of 3-5 meters.

(2) Magnetic detection errors of the compass. 1 degree of sensor error is typical, and a 1 degree error results in 1.7 meters of error per 100 meters ranging. An additional 3 degrees of compass error due to ambient and man-made magnetic fields is also typical and results in 5.1 meters of error per 100 meters ranging.

(3) Magnetic declination errors resulting from discrepancies between magnetic North and true North vary per location and time, with an error of 1 degree being typical, resulting in an error of 1.7 meters per 100 meters ranging.

(4) Ranging errors of the laser rangefinder 12 of approximately +/−1 yard.

Thus, for each remotely sighted point a user wishes to locate and mark, the computing device 18 must consider: (1) the current position (latitude, longitude) of the device; (2) the satellite navigation receiver error; (3) the horizontal distance to the target; (4) the laser rangefinder error; (5) the azimuth (angle from magnetic north); (6) declination (angle from magnetic north to true north) errors; (7) angle variation errors; and (8) the current date.

To account for the above-described factors and inaccuracies, the computing device 18 creates an “uncertainty region” for each remotely sighted point. An uncertainty region is a box centered on the location of a remotely sighted object as calculated with the two equations above. The box has a depth consisting of the laser rangefinder error plus the satellite navigation receiver error. Assuming a laser rangefinder error of 2 yards and a satellite navigation receiver error of 5 yards, the depth of the uncertainty box is 7 yds. Similarly, the uncertainty box has a width consisting of the combined compass and angle measurement errors plus the satellite navigation receiver error. Assuming a total angle error of 3 degrees, the width of the uncertainty box is (3 degrees×1.7 meters/degree×D/100)+5 yds.

For example, if a golfer ranges a flag from 400 yards and wishes to know the location of the flag, the uncertainty region would be a rectangle approximately 7 yards deep×25.4 yards wide centered around the calculated location of the flag. If the golfer then ranges the flag from the middle of the fairway, the uncertainty region would be a rectangle 7 yards deep×15.2 yards wide. If the golfer again ranges the flag from 50 yards, the uncertainty region would be a rectangle 7 yards deep×10.1 yards wide. The particular error values and uncertainty region dimensions described herein are examples only. Different error values and uncertainty regions may be used without departing from the scope of the invention.

Thus, it can be seen that remotely marking a spot from a closer distance improves the accuracy of the remote marking process. Applicant has further discovered that the accuracy of a remotely sighted and marked spot can be increased even more with a refinement process that considers multiple markings of the same spot from different locations.

An example of the refinement process is as follows. A golfer initially marks the location of a point on a golf course with the laser rangefinder 12 while standing in a first location, such as on a tee box, then marks the location of the same point a second time from a second location, such as the side of a fairway. The parameters for the first and second remote markings are as follows:

Initial Marking:
Initial position as measured with satellite navigation receiver=N 39 degree latitude, W 95 degree longitude
GPS error (GPSerr)=5 meters radius of error
Ranging horizontal distance (D) as measured with laser rangefinder=250 meters
Ranging error (Derr)=+/−1 meter
Bearing angle (A) as measured with compass=345 degrees
Estimated total magnetic error (Men)=+/−3 degrees
Magnetic error distance=D×Sin(Men)=13.08 meters

To convert each degree of latitude to meters, the latitude in degrees is multiplied times 40,008,000 meters/360 degrees=111,133.3 meters/degree (LATmpd), where 40,008,000 meters is the polar circumference of the Earth. To convert each degree of longitude to meters, the longitude in degrees is multiplied times 40,075,000 meters/360×Cos (lat), where 40,075,000 meters is the equatorial circumference of the Earth. In this particular example of N 39 degrees, this would be 111,319.4 meters/degree (LONmpd).

Great Circule refinement is not necessary for these calculations as the distances from the ranging device are limited.

As described above, the coordinates of the remotely sighted point can be calculated with the formulae:

New latitude=Original latitude+D×Sin (A)/LATmpd

New longitude=Original longitude+D×Cos (A)/LONmpd

The uncertainty region is defined by the bounding corners of:

Corner 1:
New C1 latitude=Original latitude+[(D+Derr+GPSerr)×Cos (A)−(GPSerr+Merr)×Sin (A)]/LATmpd
New C1 longitude=Original longitude+[(D+Derr+GPSerr)×Sin (A)+(GPSerr+Merr)×Cos (A)]/LONmpd

Corner 2:
New C2 latitude=Original latitude+[(D-Derr-GPSerr)×Cos (A)−(GPSerr+Men)×Sin (A)]/LATmpd
New C2 longitude=Original longitude+[(D-Derr-GPSErr)×Sin (A)+(GPSerr+Merr)×Cos(A)]/LONmpd

Corner 3:
New C3 latitude=Original latitude+[(D+Derr+GPSerr)×Cos (A)+(GPSerr+Men)×Sin (A)]/LATmpd
New C3 longitude=Original longitude+[(D+Derr+GPSErr)×Sin (A)−(GPSerr+Men)×Cos (A)]/LONmpd
Corner 4:
New C4 latitude=Original latitude+[(D-Derr-GPSerr)×Cos (A)+(GPSerr+Merr)×Sin (A)]/LATmpd
New C4 longitude=Original longitude+[(D-Derr-GPSerr)×Sin (A)−(GPSerr+Merr)×Cos (A)]/LONmpd

Thus, the uncertainty region is defined as a rectangle of:

2×(Derr+GPSerr)×2×(GPSerr+Merr)

In this example, the total uncertainty region area is 12 meters×36.17 meters, or 434 square meters, and the remotely sighted point lies in the middle of this uncertainty region at GPS coordinates: N 39.00217289, W 95.00074793. The bounding coordinates of the uncertainty region are:

| | | |
|---|---|---|
| Corner 1 | N 39.00218293 | W 95.00096779 |
| Corner 2 | N 39.00207863 | W 95.00093189 |
| Corner 3 | N 39.00226716 | W 95.00056397 |
| Corner 4 | N 39.00216286 | W 95.00052806 |

The above uncertainty region is illustrated in FIG. 10 and identified by the rectangle 106. FIG. 10 is not to scale, but is instead provided for representing the principles of the invention. The remotely sighted point lies in the middle of the rectangle and is identified by the numeral 108. In reality, the uncertainty region 106 is not a rectangle, but an arc. In this example, the total area difference between an arc and a rectangle is 7.8%, but it is weighted more heavily at the edges of the region. Since the uncertainty is not a uniform distribution over the uncertainty region, assuming a rectangle is a sufficient compromise without undue degradation of the uncertainty region.

Second Marking: To refine the above remote marking, the golfer now walks to a new location (closer to the target) and ranges the point as follows:
New position as measured with the satellite navigation receiver=N 39.00101907 degree latitude, W 94.99986059 degree longitude
GPS error (GPSerr)=4 meters radius of error
Ranging horizontal distance (D) as measured with laser rangefinder=150 meters
Ranging error (Den)=+/−1 meter
Bearing angle (A) as measured with compass=325 degrees
Estimated total magnetic error (Men)=+/−3 degrees
Magnetic error distance=D×Sin (Men)=7.8 meters

The uncertainty region for this example can be calculated using the equations outlined above. The total uncertainty region in this example is 10 meters×23.77 meters, or 237.1 square meters. The remotely sighted point lies in the middle of this uncertainty region at GPS coordinates: N 39.00212470, W 95.00085509. The bounding coordinates of the uncertainty region are:

| | | |
|---|---|---|
| Corner 1 | N 39.00210039 | W 95.00100045 |
| Corner 2 | N 39.00202669 | W 95.00093415 |
| Corner 3 | N 39.00222272 | W 95.00077604 |
| Corner 4 | N 39.00214901 | W 95.00070973 |

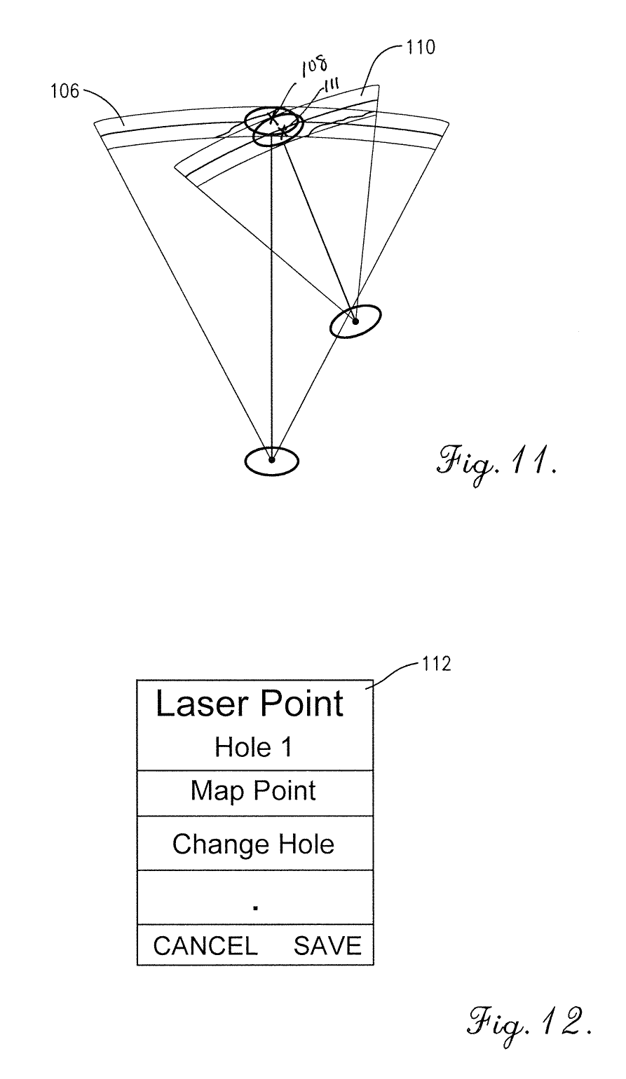

The uncertainty region is illustrated in FIG. 11 and is identified by the rectangle 110. The remotely sighted point is in the middle of the rectangle and is identified by the numeral 111. Again the figure is not to scale. To improve the accuracy of the remote marking, the computing device 18 determines the overlap between the two uncertainty regions 106, 110 and averages the two center locations. The computing device then determines whether the average of center locations falls in the overlap. If the center does not fall in the overlap or if there is no overlap, then the position and uncertainty region are defined by the closer ranging. However, if the two uncertainty areas overlap and the overage of the center locations falls within the overlap, the computing device saves the overage of the two centers as the location of the remotely sighted object.

Overlap algorithms are common and obvious use of geometry and will not be detailed here, with exception to note that the lines through the various points are extended to determine the intersect points, and then to determine if that falls on the border or within both overlap regions. This is a matrix math solution, which will arrive at eight (8) or fewer corner points for the overlap region, as the maximum number of verticies when a polygon is intersected with a four-sided polygon is n+4.

In this particular example, the overlap region results in a polygon defined by five verticies. The overlap region is:

| | | |
|---|---|---|
| Corner 1 | N 39.99939589 | W 95.00285532 |
| Corner 2 | N 39.99944750 | W 95.00276064 |
| Corner 3 | N 39.99939188 | W 95.00271061 |
| Corner 4 | N 39.99927456 | W 95.00267022 |
| Corner 5 | N 38.99926122 | W 95.00273419 |

The new center point, as the mid-point between the other centers is within the overlap region. This defines the target at: N 38.99937606, W 95.00276036. The resulting smaller uncertainty region is the portion of the rectangle 110 that overlaps the rectangle 106 as shown in FIG. 11. Again, as mentioned above, the error values and uncertainty region dimensions described herein are examples only and may be replaced with other values and dimensions without departing from the scope of the invention.

The computing device 18 may use the above-described refinement process to obtain a more accurate remote marking of a location. Although the above example only considers two remote markings in the refinement process, any number of markings may be considered. A location of a targeting object obtained in this manner may be saved in the memory 19 or 54 an/or displayed on the display for the relevant hole.

The refinement process may be automatic or may be manually initiated. For example, the computing device may automatically implement the refinement process each time a user successively ranges the same target or spot two or more times from different locations. Alternatively, the computing device may require the user to initiate a refinement process by entering a refinement mode with appropriate menu commands.

To simplify the saving of a remotely marked point, the computing device 18 may automatically prompt the user to elect whether to save the point each time the laser rangefinder 12 is used. For example, each time the fire button 34 is operated and a distance reading to a target is secured, the computing device 18 may display a screen 112 similar to the one shown in FIG. 12. The screen 112 permits the user to save the remotely marked point by selecting SAVE. If the user does not elect to save the point within a pre-determined time (e.g. 20 seconds), the location of the point is automatically discarded. Similarly, if the user operates the fire button 34 again without first saving the location, the location is discarded.

In some embodiments, the computing device may only save location data for certain remotely marked points. For example, the computing device may be programmed to save data representative of a remotely sighted object only if the distance from the current location of the device to the object as determined by the laser rangefinder is less than a threshold distance. In one embodiment, this threshold distance is 200 yards. The computing device may alternatively be programmed to save data representative of the location in memory only if an uncertainty region calculated for the location is below a selected threshold size (e.g. 250 square meters).

Although the invention has been described with reference to the exemplary embodiments illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A distance measuring device comprising:
a satellite navigation receiver operable to determine a current location of the device;
a laser rangefinder operable to determine a distance from the current location of the device to an object on a golf course;
a compass operable to determine a bearing between the current location of the device and the object;
a computing device programmed to determine a location of the object as a function of the current location of the device, the distance to the object, and the bearing between the current location of the device and the object; and
a portable handheld housing for housing the laser rangefinder, the satellite navigation receiver, the compass, and the computing device.

2. The distance measuring device as set forth in claim 1, the computing device being further programmed to calculate a distance between the object and a second object on the golf course as a function of the location of the object and pre-mapped location information for the second object.

3. The distance measuring device as set forth in claim 2, further comprising a display, the computing device being further programmed to present on the display a representation of the current location of the device, a representation of the location of the object, and a representation of the location of the second object.

4. The distance measuring device as set forth in claim 3, the computing device being further programmed to present on the display a representation of the distance between the current location of the device and the location of the object as well as a representation of the distance between the object and the second object.

5. The distance measuring device as set forth in claim 3, the computing device being further programmed to permit a user to select on the display a location between the current location of the device and the location of the second object and to calculate a distance between the current location of the device and the selected location and a distance between the selected location and the second object.

6. The distance measuring device as set forth in claim 5, the computing device being further programmed to permit the user to move the selected location on the display and to re-calculate a distance between the current location of the device and the selected location and a distance between the selected location and the second object.

7. The distance measuring device as set forth in claim 1, wherein the housing has opposed left and right sidewalls, opposed top and bottom walls, and opposed front and rear walls, all of the walls being sized and configured to permit a user to hold the device with one hand, with the user's palm placed against the left or right sidewall and the user's fingers wrapped substantially over the top wall, the device further comprising a display positioned in the sidewall opposite to the sidewall engaged by the user's palm.

8. The distance measuring device as set forth in claim 7, wherein the sidewall on which the display is mounted includes a lower inwardly extending ledge, the device further comprising a plurality of user inputs positioned on the ledge for controlling functions of the satellite navigation receiver and the display.

9. The distance measuring device as set forth in claim 2, wherein the current location is on a tee box, the object is between the tee box and a green, and the second object is a portion of the green.

10. A distance measuring device comprising:
a satellite navigation receiver operable to determine a current location of the device;
a laser rangefinder operable to determine a distance from the current location of the device to an object on a golf course;
a compass operable to determine a bearing between the current location of the device and the object;
a display; and
a computing device programmed to—
determine a location of the object as a function of the current location of the device, the distance to the object, and the bearing between the current location of the device and the object, and
save the location in memory and present on the display a representation of the location.

11. The distance measuring device as set forth in claim 10, the computing device further programmed to permit a user to select an identifier for the object and to present on the display a representation of the identifier alongside the representation of the location.

12. The distance measuring device as set forth in claim 10, the computing device further programmed to save the location in memory only if the distance from the current location of the device to the object as determined by the laser rangefinder is less than a threshold distance.

13. The distance measuring device as set forth in claim 10, the computing device further programmed to calculate a distance between the object and a second object on the golf course as a function of the location of the object and pre-mapped location information for the second object.

14. The distance measuring device as set forth in claim 10, further comprising a portable handheld housing for housing the laser rangefinder, the satellite navigation receiver, the compass, and the computing device.

15. The distance measuring device as set forth in claim 14, wherein the housing has opposed left and right sidewalls, opposed top and bottom walls, and opposed front and rear walls, all of the walls being sized and configured to permit a user to hold the device with one hand, with the user's palm placed against the left or right sidewall and the user's fingers wrapped substantially over the top wall, and wherein the display is positioned in the sidewall opposite to the sidewall engaged by the user's palm.

16. A distance measuring device comprising:
a satellite navigation receiver operable to determine a first location of the device and a second location of the device after the device has been moved;
a laser rangefinder operable to determine a first distance from the first location to an object on a golf course and to determine a second distance from the second location to the object;
a compass operable to determine a first bearing between the first location of the device and the object and a second bearing between the second location and the object; and
a computing device programmed to—
determine a location of the object as a function of the first location of the device, the first distance to the object, and the first bearing between the current location of the device and the object,
determine a revised location of the object as a function of the second location of the device, the second distance to the object, and the second bearing between the current location of the device and the object, and
calculate an estimated location of the object as a function of the location of the object and the revised location of the object.

17. The distance measuring device as set forth in claim 16, the computing device being further programmed to calculate a distance between the object and a second object on the golf course as a function of the revised location of the object and pre-mapped location information for the second object.

18. The distance measuring device as set forth in claim 16, further comprising a portable handheld housing for housing the laser rangefinder, the satellite navigation receiver, the compass, and the computing device.

19. The distance measuring device as set forth in claim 16, the computing device being further programmed to save data representative of the location of the object without the revised location and the estimated location when the distance from the current location of the device to the object as determined by the laser rangefinder is less than a threshold distance or when an uncertainty region calculated for the location is below a selected threshold.

20. The distance measuring device as set forth in claim 16, the computing device being programmed to automatically calculate the estimated location of the object whenever the laser rangefinder is used to successively determine a distance to an object from two or more different locations.

21. The distance measuring device as set forth in claim 16, the computing device being programmed to calculate the estimated location of the object only when a user initiates a refinement process.

22. A distance measuring device comprising:
a satellite navigation receiver operable to determine a current location of the device;
a laser rangefinder operable to determine a distance from the current location of the device to an object on a golf course;
a compass operable to determine a bearing between the current location of the device and the object; and
a computing device programmed to—
determine a location of the object as a function of the current location of the device, the distance to the object, and the bearing between the current location of the device and the object,
prompt the user to select whether to save the location, and
automatically discard the location if the user operates the laser rangefinder to determine another distance without first saving the location.

23. The distance measuring device as set forth in claim 22, the computing device being further programmed to prompt the user to select an identifier for the location if the user elects to save it.

24. The distance measuring device as set forth in claim 22, the computing device being further programmed to save the location in memory only if the distance from the current location of the device to the object as determined by the laser rangefinder is less than a threshold distance.

25. The distance measuring device as set forth in claim 22, the computing device being further programmed to save the location in memory only if an uncertainty region calculated for the location is below a selected threshold.
